(19) United States
(12) Patent Application Publication
(10) Pub. No.: US 2012/0181445 A1
(43) Pub. Date: Jul. 19, 2012

(54) ELECTRON BEAM RECORDING APPARATUS

(75) Inventor: Hiroaki Kitahara, Kai (JP)

(73) Assignee: PIONEER CORPORATION, Kawasaki-shi, Kanagawa (JP)

(21) Appl. No.: 13/498,544

(22) PCT Filed: Sep. 28, 2009
(86) PCT No.: PCT/JP2009/066791

§ 371 Date: Mar. 27, 2012

(51) Int. Cl. G21K 5/08

(52) U.S. Cl. 250/453.11

(57) ABSTRACT

PURPOSE

To provide an electron beam recording apparatus capable of correcting rotational runout in an order of sub-nanometer with high precision.

SOLUTION

The apparatus comprises: a displacement detector comprising at least three displacement sensors arranged at different angles to each other in radial directions of the turntable so as to detect displacement in the radial direction of a rotational side surface of the turntable; a shape calculator to calculate shape data according to a roundness error of the turntable and an eccentricity component of the turntable; a memory to store the shape data; a rotational runout computing part to calculate rotational runout of the turntable that does not include an eccentricity component according to detected displacement from the displacement sensor when the turntable rotates and the shape data; and a beam irradiating position adjuster to adjust an irradiating position of the electron beam according to the rotational runout.

### TECHNICAL FIELD

The present invention relates to an electron beam recording apparatus, particularly relates to an electron beam recording apparatus that uses electron beams to manufacture a master of high-speed rotational recording media such as magnetic discs or the like.

### BACKGROUND ART

Beam recording apparatuses that use exposure beams such as electron beams, laser beams, or the like to perform lithography are widely applied to master manufacturing apparatuses of high-capacity disks such as digital versatile discs (DVDs), optical discs such as Blu-ray discs, hard disks for magnetic recording, or the like.

The beam recording apparatuses control to form a resist layer on a recording surface of a substrate that is to become a master to manufacture the above discs/disks, rotate, and translate the substrate so as to appropriately send a beam spot to the recording surface of the substrate comparatively in a radius direction and a contact line direction such that a spiral track or concentric track is drawn on the substrate recording surface, thereby forming a latent image on the resist.

According to the beam recording apparatus, rotational runout is caused by mechanical precision or the like of a feeding motor, spindle motor, or the like to rotate and translate the substrate so as to reduce the precision of forming the track. Accordingly, it is necessary to correct the rotational runout by some methods so as to perform beam exposure.

As it is known, the rotational runout of the disc substrate is classified into synchronous runout (synchronous rotational runout) that is a deflectionary component synchronous to a rotational frequency of a turntable (substrate) and irregular asynchronous runout (asynchronous rotational runout) that does not depend on a rotational frequency of a turntable (substrate).

With reference to the asynchronous rotational runout, a correction method of an optical disc master exposing apparatus is disclosed (for example, refer to Patent Literature 1). The Patent Literature 1 discloses a technique to correct the asynchronous rotational runout such that the track pitch precision (comparative positional precision to an adjacent track) of the optical disc master exposing apparatus is improved.

In contrast, the synchronous rotational runout deteriorates the roundness precision of a track (absolute precision), however, it does not affect the precision of a track pitch. Since a roundness error caused by the synchronous rotational runout can be followed by a tracking servo of a reproducer in the case of an optical disc, attention has not been paid to the synchronous rotational runout as much as to the asynchronous rotational runout. However, in recent years, as hard disks that are magnetic recording media have had higher recording density, there has been an increasing demand for using an electron beam exposing apparatus to manufacture magnetic recording media that are called discrete track media or patterned media. Because the hard disk rotates at a high speed to record/reproduce and a controlling range of a swing arm type controlling mechanism to control tracks of a recording/reproducing head is small, the disc/disk medium is required to have highly precise track roundness. Because of this, the master exposing apparatus to manufacture the disc/disk media needs to correct the asynchronous rotational runout as well as the synchronous rotational runout precisely.

For example, controlling (correcting) an irradiating position of a recording beam according to a result of computation is disclosed, wherein displacement in a radial direction of a turntable measured by the prescribed number of rotations or smaller (hereafter, also referred to as radial displacement) is set as reference displacement and a difference from the reference displacement of the radial displacement measured real-time at the time of beam exposure is computed (for example, refer to Patent Literature 2).

However, according to this method, it is assumed that a synchronous component of rotational runout is small at the time of low speed rotation, and the rotational synchronous component increases proportionately as the number of rotations increases, wherein the displacement at the time of low speed rotation is set as a reference. However, the rotational synchronous component cannot be disregarded even at the time of low speed rotation, and moreover, the rotational synchronous component does not always increase proportionately as the number of rotations increases. Therefore, according to the method, the component of synchronous rotational runout included at the time of rotation to capture a reference displacement wave shape is unknown, hence it cannot be corrected.

### CITATION LIST

### Patent Literature

PTL 1: Japanese Patent Kokai No. H9-190651 (p. 4, FIG. 1)
PTL 2: Japanese Patent Kokai No. 2003-317285 (p. 7-8, FIG. 3)

### SUMMARY OF INVENTION

### Technical Problem

As a problem to be solved by the present invention, the above problem is included as one example. An object of the present invention as one example is to provide a high precision electron beam recording apparatus that is capable of correcting rotational runout in an order of sub-nanometer to nanometer.

### Solution to Problem

The electron beam recording apparatus according to the present invention is an electron beam recording apparatus to rotate a turntable, wherein a substrate is placed and irradiate an electron beam to a resist layer formed on the substrate according to a recording signal, thereby forming a latent image on the resist layer, wherein it comprises: a displacement detector comprising at least three displacement sensors that are arranged at a different angle to each other in a radial direction of the turntable so as to detect displacement in the radial direction of a rotational side surface of the turntable; a shape calculator to calculate shape data according to a roundness error of the turntable and an eccentricity component of the turntable; a memory to store the above shape data; a rotational runout computing part to calculate rotational runout of the turntable that does not include an eccentricity component according to detected displacement from the displacement sensor when the turntable rotates and the above shape data; and a beam irradiating position adjuster to adjust an irradiating position of the electron beam according to the above rotational runout.

The electron beam recording apparatus according to the present invention is an electron beam recording apparatus to record by rotating a turntable, wherein a substrate is placed and irradiating an electron beam to the substrate according to a recording signal, wherein it comprises: a displacement sensor to detect displacement information in a radial direction of the turntable; eccentricity component obtaining means for obtaining an eccentricity component attributed to eccentricity of the turntable according to the above displacement information; rotational runout information generating means for generating rotational runout information by subtracting the above eccentricity component from the above displacement information; and a beam irradiating position adjuster to adjust an irradiating position of the electron beam according to the above rotational runout information.

The electron beam recording apparatus according to the present invention is an electron beam recording apparatus to record by rotating a turntable, wherein a substrate is placed and irradiating an electron beam to the substrate according to a recording signal, wherein it comprises: displacement data obtaining means for obtaining displacement data that is displacement in a radial direction of the turntable; eccentricity component obtaining means for obtaining an eccentricity component attributed to eccentricity of the turntable; rotational runout information obtaining means for obtaining rotational runout information, wherein the above eccentricity component is removed from the above displacement data; and a beam irradiating position adjuster to adjust an irradiating position of the electron beam according to the above rotational runout information.

### BRIEF DESCRIPTION OF DRAWINGS

FIG. 1 is a schematic block diagram illustrating a constitution of an electron beam recording apparatus of this embodiment of the present invention.

FIG. 2 is a diagram illustrating a constitution to detect and compute rotational runout and to adjust an irradiating position of an electron beam (EB) according to the result of computation.

FIG. 3 is a schematic top view illustrating a position of a turntable and three displacement sensors.

FIG. 4 is a flow chart to calculate shape data that is Embodiment 1 of the present invention.

FIG. 5 is a diagram illustrating an example of a wave shape of roundness error data r(θ).

FIG. 6 is a diagram illustrating an example of a wave shape of eccentricity data e(θ).

FIG. 7 is a diagram illustrating an example of a wave shape of calculated shape data f(θ).

FIG. 8 is a diagram illustrating an operation of a rotational runout computing part to adjust a beam irradiating position according to shape data f(θ) stored in memory at the time of exposure.

FIG. 9 is a diagram illustrating an example of measurement radial displacement data (for example, S_{A}(θ)).

FIG. 10 is a diagram illustrating rotational runout data after shape data f(θ)==r(θ)+e(θ) is subtracted from measurement radial displacement.

FIG. 11 is a schematic diagram illustrating a modification example of the present invention and positions of four displacement sensors.

FIG. 12 is a block diagram illustrating a constitution to update shape data f(θ) and correct an irradiating position of exposure beam at the time of exposure.

### DESCRIPTION OF EMBODIMENTS

Below, the embodiments of the present invention will be described in detail by referencing to the drawings. In the following embodiments, equivalent component elements are given the same referential marks.

### [Constitution and Operation of the Electron Beam Recording Apparatus]

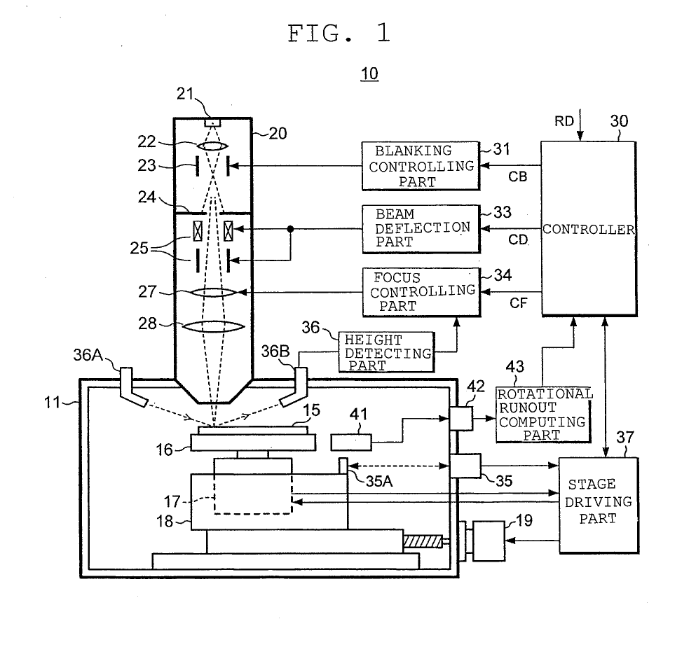

FIG. 1 is a schematic block diagram illustrating a constitution of an electron beam recording apparatus 10 of this embodiment of the present invention. The electron beam recording apparatus 10 is a disc mastering apparatus to manufacture a master for manufacturing a hard disk by using an electron beam.

The electron beam recording apparatus 10 is provided with a vacuum chamber 11, a drive mechanism to set, rotate, translate, and drive a substrate 15 arranged in the vacuum chamber 11, an electron beam column 20 installed in the vacuum chamber 11 and various circuits and controls to drive and control the substrate and control an electron beam, or the like.

More specifically, the surface of the substrate 15 for a disc master is coated with resist and set on a turntable 16. The turntable 16 is rotated and driven around a vertical axis of a primary surface of the disc substrate by a spindle motor 17 that is a rotational driving apparatus to rotate and drive the substrate 15. The spindle motor 17 is provided on a feeding stage (hereafter, also referred to as an X stage) 18. The X stage 18 is joined to a feeding motor 19 that is a transporting (translating and driving) apparatus so as to move the spindle motor 17 and turntable 16 in a prescribed direction (X direction) in a plane parallel to the primary surface of the substrate 15. Accordingly, an Xθ stage comprises an X stage 18, spindle motor 17, and turntable 16.

The spindle motor 17 and X stage 18 are driven by a stage driving part 37 and a feeding amount of the X stage 18 that is a driving amount thereof and a rotational angle of the turntable 16 (that is to say, substrate 15) are controlled by a controller 30.

The turntable 16 is made of a dielectric body, for example, ceramic, comprising a chucking mechanism such as a static chucking mechanism (not illustrated) to hold the substrate 15. The chucking mechanism secures the substrate 15 set on the turntable 16 to the turntable 16.

A reflective mirror 35A that is a part of a laser interferometer 35 is arranged on the X stage 18.

A vacuum chamber 11 is mounted via a vibration isolation table (not illustrated) such as an air dumper or the like so as to control external vibrations from being transmitted. A vacuum pump (not illustrated) is connected to the vacuum chamber 11 to exhaust the chamber such that the inner part of the vacuum chamber 11 is set to be a vacuum atmosphere having a prescribed pressure.

An electron gun (emitter) 21 to emit an electron beam, converging lens 22, blanking electrode 23, aperture 24, beam deflection electrode 25, focus lens 27, and object lens 28 are arranged in the electron beam column 20 in this order.

The electron gun 21 emits an electron beam (EB) accelerated to several dozen KeV, for example, by a negative electrode (not illustrated) wherein high voltage supplied from an accelerating voltage power source (not illustrated) is applied. Emitted electron beams are converged by the converging lens 22. The blanking electrode 23 turns on and off the electron beam according to a modulation signal from a blanking controlling part 31. That is to say, a passing electron beam is deflected considerably by applying voltage between the blanking electrodes 23, thereby the electron beam is prevented from passing the aperture 24 so as to turn off the electron beam.

The beam deflection electrode 25 is capable of deflection controlling the electron beam at high speed according to a control signal from the beam deflection part 33. By the deflection control, a spot position of the electron beam is controlled on the substrate 15. The focus lens 28 is driven according to a drive signal from the focus controlling part 34, thereby controlling a focus of the electron beam.

The vacuum chamber 11 is provided with a height detecting part 36 to detect a height of a surface of the substrate 15. An optical detector 36B that includes a position sensor, a charge coupled device (CCD), or the like, for example, receives an optical beam that is emitted from a light source 36A and reflected by the surface of the substrate 15, and supplies the received optical signal to the height detecting part 36. The height detecting part 36 detects the height of the surface of the substrate 15 according to the received optical signal so as to generate a detection signal. The detection signal indicating the height of the surface of the substrate 15 is supplied to the focus controlling part 34, and the focus controlling part 34 controls the focus of the electron beam according to the detection signal.

The laser interferometer 35 uses laser light irradiated from a light source in the laser interferometer 35 to measure a length of displacement of the X stage 18, and then feeds the measured length data, that is to say, the feeding position data of the X stage 18 (X direction) to the stage driving part 37.

Furthermore, a rotation signal of the spindle motor 17 is also supplied to the stage driving part 37. More specifically, the rotation signal includes an origin point signal indicating a reference rotational position of the substrate 15 and a pulse signal (rotary encoder signal) for every prescribed rotational angle from the reference rotational position. The stage driving part 37 obtains a rotational angle, a rotation speed, or the like of the turntable 16 (substrate 15) from the rotation signal.

The stage driving part 37 generates position data indicating the position of an electron beam spot on the substrate according to feeding position data from the X stage 18 and a rotation signal from the spindle motor 17 so as to supply them to the controller 30. The stage driving part 37 drives the spindle motor 17 and feeding motor 19 according to a control signal from the controller 30, thereby rotating and feed driving them.

Track pattern data used for discrete track media, patterned media, or the like, or data (recording data) RD to record (expose) is supplied to the controller 30.

The controller 30 sends a blanking control signal CB, deflection control signal CD, and focus control signal CF to a blanking controlling part 31, beam deflection part 33, and focus controlling part 34 respectively, thereby controlling the recording data (exposing or drawing) according to the recording data RD. That is to say, an electron beam (EB) is irradiated to the resist on the substrate 15 according to the recording data RD, wherein a latent image is formed only at a spot exposed by irradiating the electron beam so as to be recorded (exposed).

Furthermore, an electron beam recording apparatus 10 is provided with a displacement detecting apparatus 41 to detect displacement in the radius direction (hereafter, referred to as a radial direction) when the turntable 16 rotates. More specifically, the turntable 16 is in a cylindrical shape and the substrate is set on the primary surface thereof (primary flat surface). The turntable 16 is rotated and driven around the central axis thereof, and the displacement detecting apparatus 41 detects displacement in the radius direction (radial direction) of the side surface of the turntable 16. As described below, the displacement detecting apparatus 41 comprises at least three displacement sensors.

The displacement (detected displacement) detected by the displacement detecting apparatus 41 is supplied to a rotational runout computing part 43. It is acceptable to constitute such that an amplifying apparatus 42 to amplify the detection signal is provided and the amplified detection signal is supplied from the amplifying apparatus 42 to the rotational runout computing part 43.

The rotational runout computing part 43 performs a prescribed computation of the detected displacement so as to calculate rotational runout. The calculated rotational runout is supplied to the controller 30. The controller 30 controls the beam deflection part 33 according to the calculated rotational runout, thereby adjusting (correcting) an irradiating position of an electron beam.

The recording control is performed according to the above feeding position data and rotating position data. A primary signal line has been described in relation to the blanking controlling part 31, beam deflection part 33, focus controlling part 34, and stage driving part 37. Each of these constituent parts is constituted to be connected to the controller 30 bilaterally so as to transmit or receive a required signal.

### [Calculation of Roundness Error, Detection and Computation of Rotational Runout]

Then, the constitution and operation of the electron beam recording apparatus 10 will be described in detail by referencing drawings, wherein the rotational runout is detected and computed so as to adjust the irradiating position of a beam according to the rotational runout.

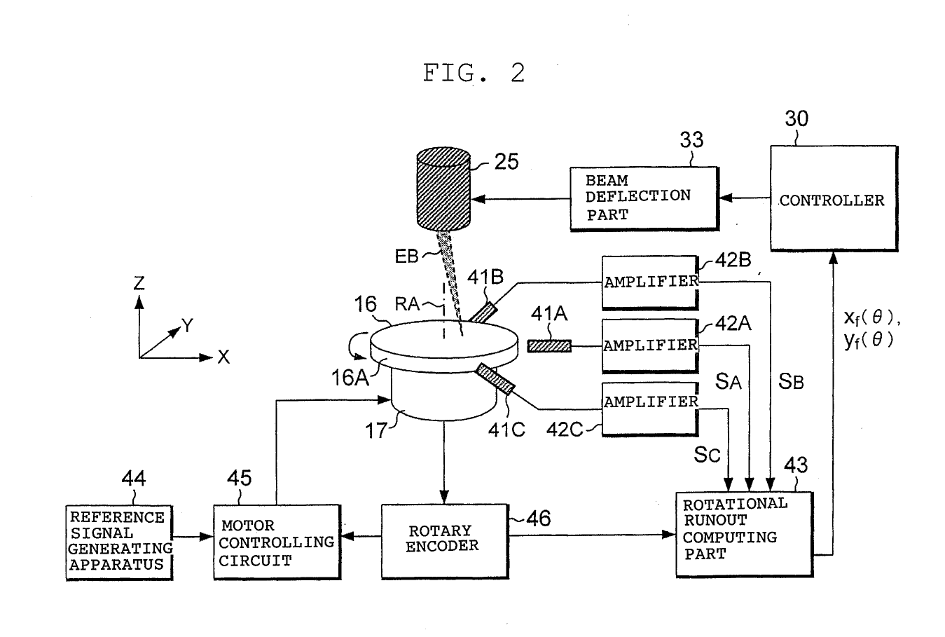

FIG. 2 is a diagram illustrating a constitution to detect and compute rotational runout and to adjust an irradiating position of an electron beam (EB) according to the result of computation.

The substrate 15 (not illustrated) is set on the primary surface (xy flat surface) of the turntable 16 and, as illustrated in FIG. 2, is rotated around the central axis thereof (Z direction: indicated as a rotational central axis RA) by the spindle motor 17. The side surface 16A of the turntable 16 is in a cylindrical shape.

Rotations of the spindle motor 17 to rotate the turntable 16 is controlled by a motor controlling circuit 45. The motor controlling circuit 45 operates according to a reference signal from a reference signal generating apparatus 44 and a rotary encoder signal from a rotary encoder 46. The rotary encoder signal from the rotary encoder 46 is supplied to a rotational runout computing part 43.

The rotational runout computing part 43 operates with the rotary encoder signal as a reference clock. That is to say, the rotational runout computing part 43 operates at a timing of a rotational angle reference of the turntable 16 based on the rotary encoder signal.

First, the rotational runout computing part 43 calculates a roundness error indicating an error from a true circle in a side shape of the turntable 16 that is a cylindrical surface measured in advance. As a method to calculate the roundness error, a computation method based on the principle of three-point method of measuring a true circle is available. Below, the displacement sensor to measure a roundness error r(θ) and a rotational runout computation will be described.

As illustrated in FIG. 2, three displacement sensors 41A, 41B, 41C (first, second, third displacement sensors respectively) that are displacement detecting apparatuses 41 are provided around the side surface 16A of the turntable 16. The first, second, third displacement sensors 41A, 41B, 41C detect displacement of the side surface (cylindrical surface) 16A (hereafter, simply referred to as a cylindrical surface 16A, too) of the turntable when it rotates, that is to say, displacement in the radius direction (hereafter, also referred to as radial displacement) of the turntable when it rotates. A signal detected by the displacement sensors 41A, 41B, 41C is amplified by a first to third amplifiers 42A, 42B, 42C comprising the amplifying apparatus 42 respectively, and then supplied to the rotational runout computing part 43 as a first to third displacement detection signals S_{A}, S_{B}, S_{C} respectively.

The displacement sensors 41A, 41B, 41C detect the radial displacement of the side surface of the turntable 16A by an optical method, electric method, or the like. For example, the displacement sensors 41A, 41B, 41C are constituted to be a laser interferometer, having adequate detecting precision (for example, detecting precision in sub-nanometer (that is to say, 1 nm or smaller)) compared to the precision of a beam exposure. Detection of displacement is not limited by an optical method such as a laser interferometer and displacement may be detected by other methods. For example, it is possible to use a static capacity type displacement meter or the like to detect radial displacement according to a change in an electrostatic capacity.

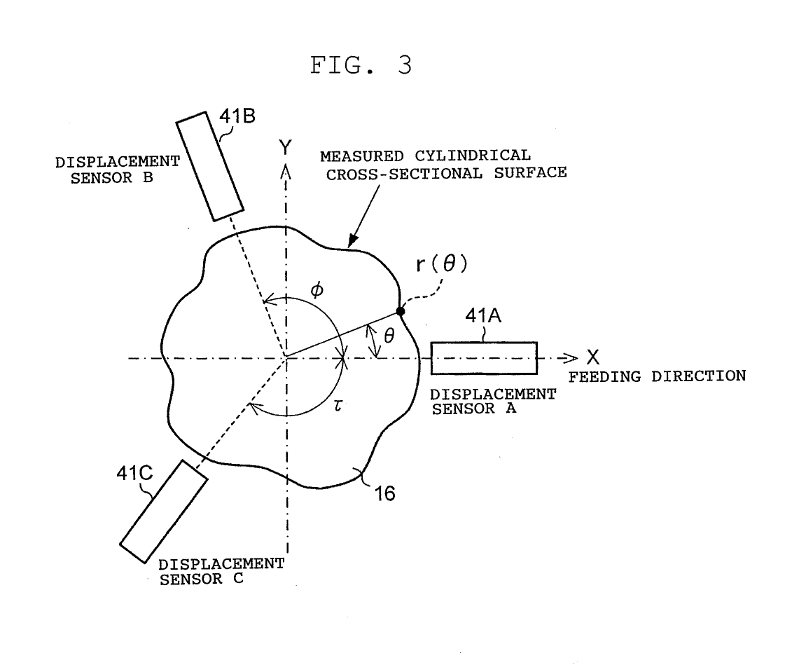

FIG. 3 is a schematic top view illustrating the arrangement of the turntable 16, displacement sensors 41A, 41B, 41C.

The displacement sensor 41A is arranged in the X direction, while the displacement sensors 41B, 41C are arranged to be at an angle φ, (2π−τ) to the displacement sensor 41A (φ, τ>0). If a rotational angle θ is made with reference to the direction of the displacement sensor 41A (X direction), a roundness error of the cylindrical surface 16A to be measured can be written as r(θ) in the polar coordinate system. The roundness error (hereafter, also referred to as roundness error data) r(θ) can be written as an error from a true circle with a reference radius r₀.

The spindle motor 17 is caused to rotate so as to measure the radial displacement of the cylindrical surface measured (turntable side surface) 16A. The radial displacement data S_{A}(θ), S_{B}(θ), S_{C}(θ) (the direction that becomes distant from the sensor is positive) from each of the displacement sensors 41A, 41B, 41C are sent to the rotational runout computing part 43, wherein they are sampled to be triggered by a pulse from the rotary encoder 46 and then subjected to digital/analog (D/A) conversion. In this case, if necessary, it is acceptable to perform a process such as filtering, averaging, or the like. By using the roundness error data r(θ) obtained in this manner and the radial displacement data S_{A}(θ), S_{B}(θ), S_{C}(θ) measured by the displacement sensors 41A, 41B, 41C, rotational runout data x(θ), y(θ) in the X and Y directions are obtained by the following computation.

x(θ)=[{S_{B}(θ)+r(θ−φ)} cos τ−{S_{C}(θ)+r(θ+τ)} cos φ]/sin(θ+τ)y(θ)=−r(θ)−S_{A}(θ)

The principle of three-point method of roundness measurement is described in detail, for example, in Non-Patent Literature “Transactions of the Japan Society of Mechanical Engineers, C, Volume 48, No. 425, p. 115 (Sho 57-1)” or the like.

However, in principle, the above roundness error data r(θ) does not include a first degree Fourier component, that is to say, an eccentricity component of the turntable side surface 16A. Whereas, each radial displacement data to be measured includes an eccentricity component of the turntable side surface, hence computed rotational runout x(θ), y(θ) include the eccentricity component of the turntable side surface 16A.

However, the eccentricity of the turntable side surface 16A does not correspond to the eccentricity of the substrate to be drawn, and it is merely the eccentricity of the cylindrical surface measured. If recording position correction is performed accordingly, it results in only recording a deflected concentric circle to the rotation center of the substrate that is set thereon.

The level of the rotational runout of the electron beam recording apparatus to which the present invention is applied is in sub-nanometer to nanometer, whereas the level of the eccentricity of the turntable side surface is normally in sub-micrometer to micrometer even if it is installed and adjusted precisely. Because of this, if the above rotational runout x(θ), y(θ) are used to perform recording position correction, an exposure beam is caused to deflect more than necessary because recording position correction of an eccentricity component of the turntable side surface is performed, which is not originally required. If an electron beam is deflected large as described above, aberration of an electron beam is caused to increase, which is disadvantageous to form a minute pattern.

Furthermore, it is not preferred that the beam irradiating position adjustment apparatus has a wide range of beam deflection in micrometer so as to correct rotational runout in nanometer, which is the original objective, from a viewpoint of an S/N ratio of a beam deflection signal.

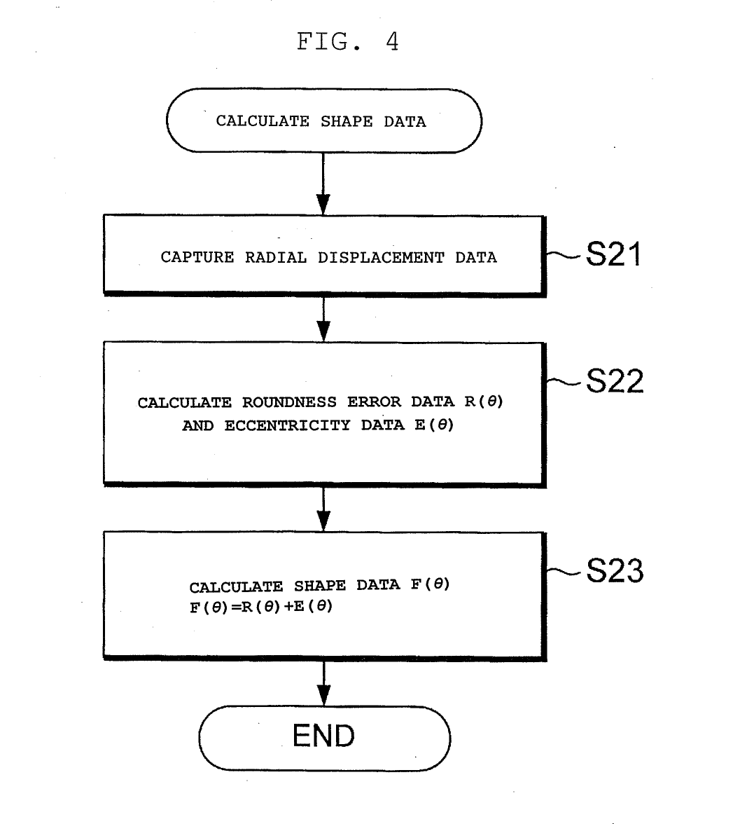

The correction system of rotational runout of the present invention is constituted to reduce the amplitude of the rotational runout correction by using rotational runout data that does not include an eccentricity component. FIG. 4 is a flow chart to calculate shape data of the recording apparatus that is Embodiment 1 of the present invention.

First, radial displacement data S_{A}(θ), S_{B}(θ), S_{C}(θ) of the turntable side surface 16A are captured by each of the displacement sensors 41A, 41B, 41C. The rotational runout computing part 43 calculates the true roundness from the radial displacement data S_{A}(θ), S_{B}(θ), S_{C}(θ) by the three-point method of roundness measurement so as to set it as roundness error data r(θ) (Step S22). As described above, the roundness error data r(θ) obtained by the three-point method of roundness measurement does not include the first degree Fourier component, that is to say, the eccentricity component.

The eccentricity data e(θ) is calculated (Step S22). The eccentricity data e(θ) can be obtained by analyzing the radial runout data of the displacement sensor by Fourier transform, for example. Specifically, the radial runout data S_{A}(θ) sampled is subjected to Fourier transform so as to extract only the first degree component, wherein reverse Fourier transform is performed, thereby obtaining the eccentricity data e(θ).

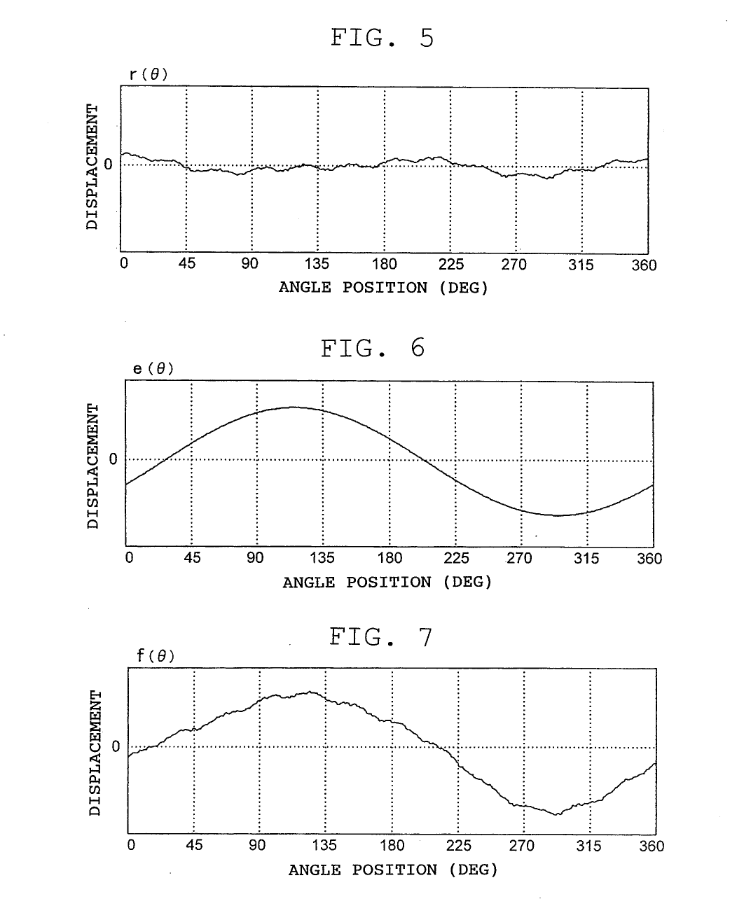

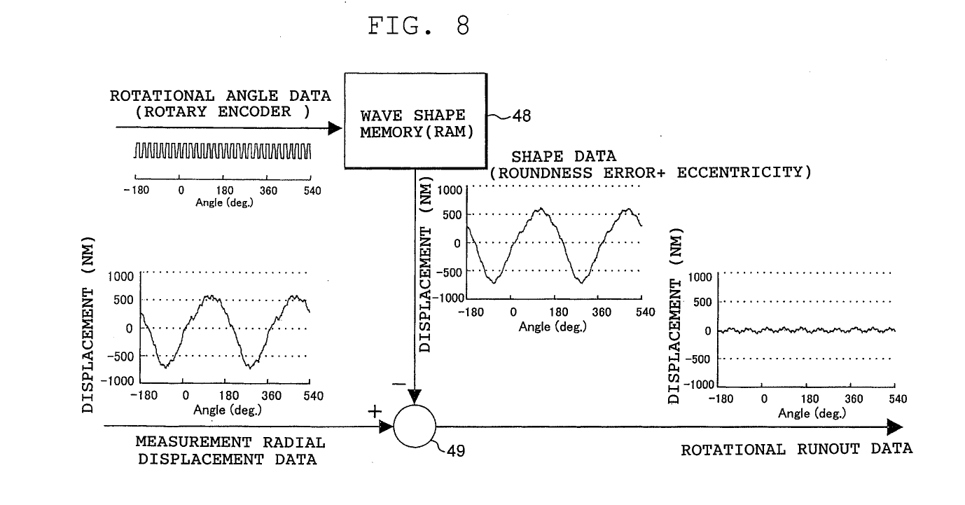

The eccentricity data e(θ) is added to the roundness error data r(θ) calculated so as to calculate shape data f(θ) (Step S23). FIGS. 5, 6, 7 illustrate an example of a wave shape of the roundness error data r(θ), eccentricity data e(θ), and the shape data f(θ) calculated respectively. The shape data f(θ) obtained in this manner is stored in a memory such as an RAM or the like provided in the rotational runout computing part 43 or the like.

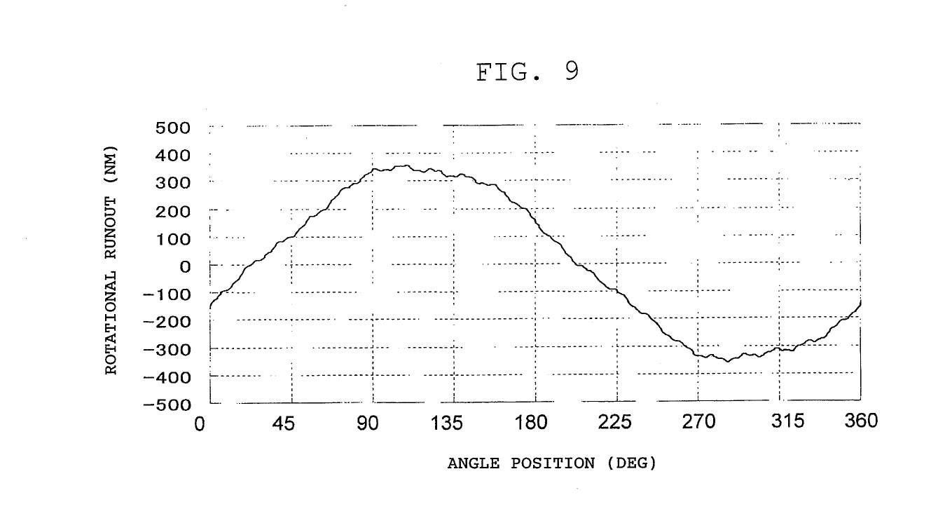

By referencing FIG. 8, adjustment of the beam irradiating position that the rotational runout computing part 43 performs at the time of exposure according to the shape data f(θ) will be described.

The shape data f(θ) is stored in a memory (RAM) 48. The rotational runout computing part 43 reads the shape data f(θ) (=r(θ)+e(θ)) stored in the memory (RAM) 48 according to the data (rotary encoder signal) of a rotational angle (angle position θ) from the rotary encoder 46 (FIG. 2), and then sends it to a subtractor 49 provided in the rotational runout computing part 43. Measurement radial displacement data S_{A}(θ), S_{B}(θ), S_{C}(θ) amplified by each of the displacement sensors 41A, 41B, 41C (or after amplified by the amplifiers 42A, 42B, 42C) are supplied to the subtractor 49 real-time so as to subtract the shape data f(θ).

The rotational runout computing part 43 executes the above computation such as a subtraction or the like by high-speed processing means such as a digital signal processor (DSP) or the like. Accordingly, two-dimensional rotational runout components x_{f}(θ), y_{f}(θ) are calculated in the X and Y direction real-time.

Herein, the rotational runout component data x_{f}(θ), y_{f}(θ) are expressed as follows:

x_{f}(θ)=[{S_{B}(θ)+f(θ−φ)} cos τ−{S_{C}(θ)+f(θ+τ)} cos φ]/sin(θ+τ) (1)

y_{f}(θ)=−f(θ)−S_{A}(θ) (2)

The wave shape data x_{f}(θ), y_{f}(θ) obtained in this manner are supplied to the controller 30. The controller 30 controls the beam deflection part 33 according to the rotational runout data x_{f}(θ), y_{f}(θ) calculated, thereby adjusting (correcting) the irradiating position of the electron beam (EB) real-time. That is to say, the irradiating position of the exposure beam (electron beam) is displaced according to a rotational runout signal, thereby performing recording position correction.

As described above, the rotational runout data x_{f}(θ), y_{f}(θ) do not include the eccentricity component. Because of this, it becomes possible to reduce the deflection range of the beam irradiating position adjustment apparatus. As a result, it is possible to control the effect of the rotational runout and record a precise concentric circle and a spiral pattern without deteriorating a drawing pattern caused by a beam deflection aberration or deflection noise.

Herein, it is preferred to match a setting angle of one of the displacement sensors (sensor A) with a feeding direction of the feeding stage (X stage) (refer to FIG. 3). That is to say, it is the rotational runout in the stage feeding direction, which is the radial direction of the turntable, that actually affects the track roundness error at the time of exposure of a disc master. Therefore, by setting one of the three displacement sensors (sensor A) in the stage feeding direction, the rotational runout in the stage feeding direction can be obtained by the following simple subtraction equation. Since the computation process at the time of correction becomes streamlined, it is advantageous in that real-time correction becomes easy to perform.

y_{f}(θ)=f(θ)−S_{A}(θ) (3)

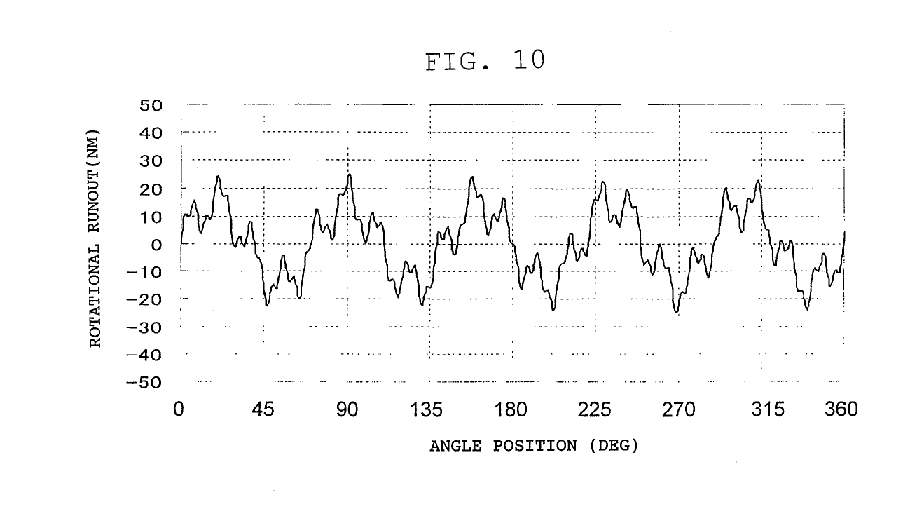

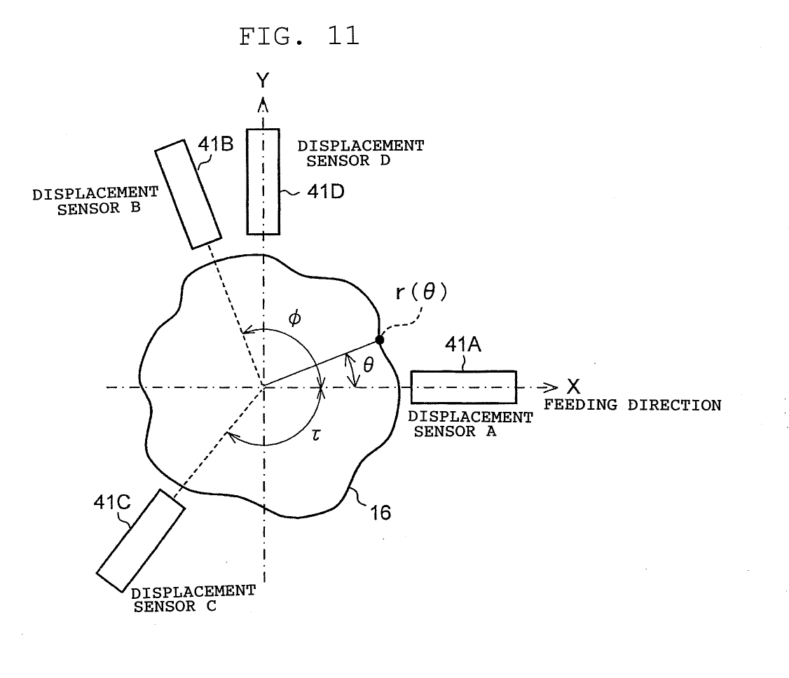

FIG. 9 is an example of measurement radial displacement data (for example, S_{A}(θ)). As described above, the amplitude of the measurement radial displacement is in an order of sub-micrometer to micrometer (refer to FIG. 8). FIG. 10 illustrates rotational runout data after shape data f(θ)=r(θ)+e(θ) is subtracted from the measurement radial displacement. The amplitude of the rotational runout that does not include the eccentricity component is in an order of several dozen nanometers. By using the rotational runout data, it is understood that the deflection range of the beam irradiating position correction can be considerably small.

As described above, according to the present invention, the shape data f(θ) is obtained by adding the eccentricity data e(θ) to the roundness error data r(θ) calculated according to the principle of three-point method of roundness measurement. Each radial displacement data measured real-time and the shape data f(θ) are computed, thereby calculating the rotational runout data. Since the beam irradiating position adjustment is performed according to the rotational runout data that does not include the eccentricity component, it is possible to reduce the deflection range of the position adjustment correction and record a precise concentric circle and a spiral pattern.

There is a method to calculate and subtract the eccentricity data from the radial runout data measured real-time at the time of the position adjustment and then the roundness error data is used to compute the rotational runout data, however, the computation becomes complex. Moreover, there is a method to calculate and subtract the eccentricity component from the rotational runout data computed by using the roundness error data, however, the computation is complex and this is disadvantageous to the real-time computation process at the time of the position adjustment.

In this embodiment, the displacement sensors 41A to 41C that had measurement sensitivity in sub-nanometer were used, however, it is acceptable to add an adjustment mechanism to adjust the position (height) of the displacement sensors 41A to 41C such that an error is not made in the height when the sensor is installed (measurement height of radial displacement). The height adjustment mechanism adjusts the position (height) of the displacement sensors 41A to 41C such that an error of the shape data f(θ) remains in a prescribed range when the shape data f(θ) is obtained by the controller 30, for example.

The direction to arrange the displacement sensor is not limited to the one illustrated in FIG. 3, and it may be arranged in any direction. However, depending on a combination of the relative angles φ, τ of the displacement sensors 41A to 41C, the computation diverges, wherein a Fourier series component that is undetectable may occur. Hence, it is preferred to set them at a comparative angle such that all Fourier components up to a possible highest degree can be detected.

Moreover, it is predominantly the rotational runout component in the X direction of the stage feeding direction, which is the radial direction of the turntable 16 (substrate 15), that actually affects the track roundness error at the time of exposure of a disc master. Accordingly, as described above, it is preferred to set one of the three displacement sensors 41A to 41C in the X direction (feeding direction). In this case, the X direction is a simple subtraction, which has advantage in that the computation process at the time of correction becomes streamlined.

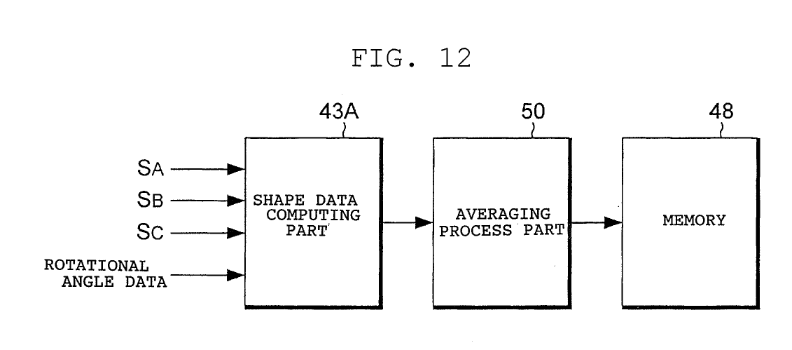

Furthermore, as illustrated in FIG. 11, it is acceptable to use four displacement sensors 41A to 41D, wherein two of them may be set in the X direction (displacement sensor 41A) and Y direction (displacement sensor 41D). In the computation of the three-point method of roundness measurement, the remaining two sensors are placed at an angle such that the computation does not diverge in a range up to Fourier order required. By placing them this way, it becomes possible to streamline and speed up the real-time computation at the time of exposure.

Moreover, in the above embodiment, the adjustment of the irradiating position of the exposure beam was described by using the shape data f(θ) that was obtained in advance and stored in the memory (RAM) 48, thereby obtaining the rotational runout data X_{f}(θ), y_{f}(θ). However, it is acceptable to calculate the shape data real-time and then adjust the irradiating position real-time. That is to say, the shape data f(θ) at the time of recording (at the time of exposure) the electron beam irradiated to the substrate may be calculated, wherein the wave shape data r(θ) thereof is used to calculate the real-time rotational runout data X_{f}(θ), y_{f}(θ), thereby adjusting the irradiating position of the electron beam.

Furthermore, it is acceptable to calculate the real-time shape data and then update the shape data f(θ). That is to say, for example, as illustrated in FIG. 12, the shape data computing part 43A calculates the shape data f(θ) real-time at the time of exposure so as to supply it to the averaging process part 50. The averaging process part 50 successively updates the shape data f(θ). For example, a movement average computation of the shape data f(θ) is performed for a plurality of rotations, and the shape data f(θ) stored in the memory (RAM) 48 is accordingly updated with the movement average wave shape data. For example, the averaging process part 50 is controlled to update the stored shape data f(θ) for every rotation.

As illustrated in FIG. 5, the rotational runout computing part 43 uses the average shape data f(θ) updated real-time at the time of exposure to calculate the rotational runout data X_{f}(θ), y_{f}(θ) so as to supply to the controller 30.

As described above, if the measurement height position is changed by thermal expansion of the turntable or spindle, and even if the measurement cross-sectional wave shape of the turntable is changed, by constituting to update the shape data f(θ) real-time, the result of computing the rotational runout does not produce an error, hence a long time exposure is possible.

### REFERENCE SIGNS LIST

10 . . . BEAM RECORDING APPARATUS
15 . . . SUBSTRATE
16 . . . TURNTABLE
17 . . . SPINDLE MOTOR
18 . . . FEEDING STAGE
25 . . . BEAM DEFLECTION ELECTRODE
30 . . . CONTROLLER
33 . . . BEAM DEFLECTION PART
37 . . . STAGE DRIVING PART
41 . . . DISPLACEMENT DETECTING APPARATUS
41A, 41B, 41C, 41D . . . DISPLACEMENT SENSOR
43 . . . ROTATIONAL RUNOUT COMPUTING PART
43A . . . SHAPE DATA COMPUTING PART
45 . . . MOTOR CONTROLLING CIRCUIT
46 . . . ROTARY ENCODER
48 . . . MEMORY
49 . . . SUBTRACTOR
50 . . . AVERAGING PROCESS PART

1. An electron beam recording apparatus to rotate a turntable, wherein a substrate is placed and irradiate an electron beam to a resist layer formed on the substrate according to a recording signal, thereby forming a latent image on the resist layer, wherein it comprises:
a displacement detector comprising at least three displacement sensors that are arranged at a different angle to each other in a radial direction of the turntable so as to detect displacement in the radial direction of a rotational side surface of the turntable;
a shape calculator to calculate shape data according to a roundness error of the turntable and an eccentricity component of the turntable;
a memory to store the shape data;
a rotational runout computing part to calculate rotational runout of the turntable that does not include an eccentricity component according to detected displacement from the displacement sensor and the shape data when the turntable rotates; and
a beam irradiating position adjuster to adjust an irradiating position of the electron beam according to the rotational runout.

2. The electron beam recording apparatus as recited in claim 1, wherein the eccentricity component of the turntable is calculated according to displacement in the radial direction of the displacement sensor.

3. The electron beam recording apparatus as recited in claim 1, wherein the roundness error is calculated by a three-point method of roundness measurement according to detected displacement detected by the displacement detector.

4. The electron beam recording apparatus as recited in claim 1, wherein the shape calculator comprises an eccentricity calculator to calculate an eccentricity component of the turntable side surface for a rotational angle of the turntable according to detected displacement of the displacement sensor.

5. The electron beam recording apparatus as recited in claim 1, wherein the shape calculator calculates the shape data by adding the roundness error calculated by the roundness error calculator and the eccentricity component of the turntable side surface calculated by the eccentricity calculator.

6. The electron beam recording apparatus as recited in claim 1, wherein the rotational runout computing part calculates rotational runout of the turntable according to the shape data and the detected displacement from the displacement sensor when the turntable rotates.

7. The electron beam recording apparatus as recited in claim 1, wherein the rotational runout computing part calculates rotational runout of the turntable according to displacement data by subtracting each eccentricity component of the turntable side surface calculated by the eccentricity calculator in advance from the detected displacement from the displacement sensor and the roundness error.

8. The electron beam recording apparatus as recited in claim 1, wherein the rotational runout computing part calculates rotational runout by subtracting the eccentricity component of the turntable side surface calculated by the eccentricity calculator from the rotational runout of the turntable calculated according to the detected displacement and the roundness error from the displacement sensor.

9. The electron beam recording apparatus as recited in claim 1, wherein it comprises a feeding stage to transport the turntable to a radial direction of the turntable and one of the displacement sensors is arranged in the transporting direction.

10. The electron beam recording apparatus as recited in claim 9, wherein the displacement detector comprises four displacement sensors, wherein one of the four displacement sensors is arranged in a direction perpendicular to the displacement sensor arranged in the transporting direction.

11. The electron beam recording apparatus as recited in claim 1, wherein the rotational runout computing part calculates rotational runout according to the calculated shape data that is calculated before an electron beam is recorded in the substrate.

12. The electron beam recording apparatus as recited in claim 1, wherein it comprises an averaging process part to average the shape data by rotating the turntable a plurality of times, wherein the rotational runout computing part calculates rotational runout data according to the averaged shape data.

13. The electron beam recording apparatus as recited in claim 1, wherein it further comprises a shape data updating part to update the shape data.

14. An electron beam recording apparatus to record by rotating a turntable, wherein a substrate is placed and irradiating an electron beam to the substrate according to a recording signal, wherein it comprises:
a displacement sensor to detect displacement information in a radial direction of the turntable;
eccentricity component obtaining means for obtaining an eccentricity component attributed to eccentricity of the turntable according to the displacement information;
rotational runout information generating means for generating rotational runout information by subtracting the eccentricity component from the displacement information; and
a beam irradiating position adjuster to adjust an irradiating position of the electron beam according to the rotational runout information.

15. The electron beam recording apparatus as recited in claim 14, wherein the rotational runout information generating means generates the rotational runout information according to a shaping component of the turntable and the eccentricity component.

16. The electron beam recording apparatus as recited in claim 15, wherein it comprises error information means for obtaining roundness error information of the turntable;
wherein the rotational runout information generating means generates the rotational runout information according to the roundness error information and the eccentricity component.

17. An electron beam recording apparatus to record by rotating a turntable, wherein a substrate is placed and irradiating an electron beam to the substrate according to a recording signal, wherein it comprises:
displacement data obtaining means for obtaining displacement data that is displacement in a radial direction of the turntable;
eccentricity component obtaining means for obtaining an eccentricity component attributed to eccentricity of the turntable;
rotational runout information obtaining means for obtaining rotational runout information, wherein the eccentricity component is removed from the displacement data; and
a beam irradiating position adjuster to adjust an irradiating position of the electron beam according to the rotational runout information.

18. The electron beam recording apparatus as recited in claim 1, wherein the turntable is rotated with eccentricity.
